(19) United States
(12) Patent Application Publication
(10) Pub. No.: US 2026/0211087 A1
(43) Pub. Date: Jul. 23, 2026

(54) LIDAR DEVICE FOR A VEHICLE AND METHOD FOR OPERATING A LIDAR DEVICE

(71) Applicant: Valeo Detection Systems GmbH, Bietigheim-Bissingen (DE)

(72) Inventors: Christoph Parl, Bietigheim-Bissingen (DE); Frank Selbmann, Bietigheim-Bissingen (DE); Juergen Nies, Bietigheim-Bissingen (DE); Jochen Schenk, Bietigheim-Bissingen (DE)

(73) Assignee: Valeo Detection Systems GmbH, Bietigheim-Bissingen (DE)

(21) Appl. No.: 19/136,634

(22) PCT Filed: Dec. 5, 2023
(86) PCT No.: PCT/EP2023/084199

§ 371 Date: Jun. 6, 2025

(30) Foreign Application Priority Data
Dec. 6, 2022 (DE) 10 2022 132 330.7

(51) Int. Cl. G01S 7/484; G01S 17/931

(52) U.S. Cl. CPC G01S 7/484; G01S 17/931

(57) ABSTRACT

Described is a lidar device for a vehicle and a method for operating a lidar device. The lidar device has an optical transmission unit with a transmission light source for transmitting transmission light, an optical receiving unit with an optical receiving sensor, and a controller configured to control the lidar device such that the receiving sensor is ready to receive at a readiness time which depends on internal reflections, where the internal reflections relate to reflections of the transmission light within the lidar device.

### TECHNICAL AREA

The application relates to a lidar device for a vehicle, a vehicle having a lidar device, and a method for operating the lidar device.

### BACKGROUND

Modern vehicles (automobiles, vans, trucks, motorcycles, etc.) have a plurality of sensors, the data of which are used for driver information and/or are provided to driver assistance systems. The surroundings of the vehicle and other road users are detected via the sensors. Based on the detected data, a model of the vehicle surroundings can be generated and it is possible to react to changes in these vehicle surroundings.

Lidar systems are continuously refined for various functions, for example for detecting surroundings information at close range and long range of vehicles, such as passenger vehicles or utility vehicles. Lidar systems can also be used as sensor systems for driver assistance systems, in particular assistance systems for autonomous or semiautonomous vehicle control. They can be used in particular to identify obstacles and/or other road users in the front area, rear area, or in the blind spot area of a vehicle. The distance determination is of particular importance in this case.

One important sensor principle for detecting the surroundings, for example of vehicles, is lidar technology in this case (lidar: light detection and ranging). A lidar system comprises an optical emitting unit and an optical receiving unit. The emitting unit can emit emission light. In particular laser light in the ultraviolet, visible, or infrared range can be used as the light in a lidar system. The emitted light can be received as reception light by the receiving unit after reflection on an object in a monitoring area in the surroundings of the lidar system.

The reception light can be evaluated using the emission light by a computing unit of the lidar system and in particular the spatial location and the distance of the object at which the reflection took place can be determined. Reflection or reflected light is understood in the present case as any reflected light and in particular is also to comprise light reflected by scattering or absorption-emission.

The lidar system can be designed as a system operating using light flashes, a so-called flash lidar. An area of the surroundings can be illuminated using a light flash here and the reception signals reflected on any possible objects can be detected using the receiving unit. Scanning lidar systems emit light beams which move in a scanning direction. Spot scanners illuminate areas of the surroundings spot by spot. Line scanners illuminate areas of the surroundings line by line.

A receiver assembly having a light-sensitive element is described in DE102017202957A1. The receiver assembly is capable of receiving light pulses using the light-sensitive element and outputting a corresponding reception signal, which is used for object detection. The sensitivity of the light-sensor element is set via a bias voltage and increased during a measuring cycle.

### OVERVIEW

A lidar device for a vehicle comprises an optical emitting unit having an emitting light source for emitting emission light and an optical receiving unit having an optical receiving sensor. A controller of the lidar device is configured to actuate the lidar device so that the receiving sensor is ready to receive at a readiness time dependent on internal reflections, wherein the internal reflections relate to reflections of the emission light within the lidar device.

From the time of the readiness to receive, even very close objects can be measured by the lidar device in distance, position, and/or velocity. Furthermore, the lidar device can be constructed more compactly, since a complex optical isolation of emitting light source and receiving sensor can be omitted. This is reasonable, for example, in coaxially constructed lidar devices, in which optical elements for emitter and receiver can be used jointly.

In a method for operating the above-described lidar device, the lidar device is actuated so that the receiving sensor is ready to receive at a readiness time dependent on internal reflections, wherein the internal reflections relate to reflections of the emission light within the lidar device. The detection distance of the lidar device can be expanded by the very close distance by way of the method.

The receiving sensor comprises at least one light-sensitive element for receiving reflected emission light which was reflected, for example, on an object in a detection area of the lidar device. An output signal for further use in the vehicle can be generated by evaluation of emission light and reception light, for example, by the controller of the lidar device. A cycle having emission of emission light and reception of the reflected light can be referred to as a measuring cycle. The duration of a measuring cycle can be in the range of nanoseconds. The output signal can comprise information on the distance of the object, the relative velocity of the lidar device in relation to the object, and/or information on the nature of the object.

The light-sensitive element can comprise high-sensitivity light sensors such as an avalanche photodiode (APD), which can also be designed as a so-called single photon avalanche diode (SPAD), also called Geiger mode APD. A SPAD or Geiger mode APD can be designed, for example, for the sensitivity of a single photon. However, the threshold can also be set higher, for example to detect a light pulse, for example in order to take background noise into consideration. Multiple APDs or SPADs can be assembled to form a so-called silicon photomultiplier (SiPM), in which they are interconnected in a field. Individual diodes of such a field are also referred to as cells.

Such high-sensitivity light sensors have the property that they have a strongly reduced light sensitivity after the triggering, for example due to a single photon, for a certain time (dead time), in which they are not or almost not ready to receive.

Internal reflections, also called back reflections, can occur in the lidar device. The internal reflections can in particular relate to reflections of the emission light on at least one optical element of the emitting unit, the receiving unit, and/or the housing, in particular a glass cover of the housing. In particular, these can already cause triggering of the receiving sensor upon the initial emission of the emission light, for example, by reflection on the housing, on the emitting/receiving optical unit, on the optical cover glass, on a possible additional window in front of the system, and/or on other components within the lidar device. This can occur in the described lidar devices for vehicles, since the emitted light power can be several hundred watts and individual photons can be sufficient to trigger the receiving sensor.

The controller of the lidar device actuates the lidar device so that the receiving sensor is ready to receive at a readiness time dependent on internal reflections. This offers the advantage that the readiness to receive can be shifted to a favorable time within the measuring cycle. For example, the readiness to receive can be shifted to a time within a measuring cycle at which the internal reflections have already decayed. This is equivalent to a shift of the readiness to receive of the receiving sensor to a time at which it is expected that the internal reflections will have already decayed.

This has the advantage that the light received from the readiness to receive of the receiving sensor can be used for the evaluation and therefore, for example, for the measurement. This has the advantage that the lidar device is already capable at close range of performing evaluations, thus, for example, measuring distances. A minimum distance which an object to be detected has to have from the lidar device can be selected as significantly smaller or can even be dispensed with entirely.

Ignoring recorded data in the first nanoseconds in order to suppress incorrect measurements due to internal reflections can thus be omitted. The duration of the first nanoseconds results here from the pulse length of the emission light and the distance which internal reflections cover within the device. As a result of this, the minimum distance which one has to have from the lidar device to be detected can therefore be up to several meters. The described lidar device offers the advantage in relation thereto of being able to be implemented without discarding received reflected emission light in the first nanoseconds and therefore with a much shorter minimum distance to detectable objects.

In addition, the lidar system can more reliably detect a so-called blockage. A blockage can occur, for example, due to contaminants of the optical unit of the device, in particular externally on the device, in particular, for example, on the cover glass of the lidar device. Due to the so-called blockage, the lidar device is not capable of performing evaluations, for example object detections. A further advantage of the described lidar device is thus that blockages of the device can be identified reliably, since received light can be evaluated directly from the time of the readiness to receive of the receiving sensor.

In embodiments, the lidar device is configured to begin the emission of the emission light at an emission time, wherein the readiness time of the receiving sensor depends on the emission time of the emission light. The emission time of the emission light can in particular coincide here with the readiness time. In other embodiments, the emission time can be before the readiness time, however, the emission of the emission light can be controlled here, for example, so that the full power is first achieved with the readiness time.

The readiness time can furthermore depend on the ambient light intensity and/or the temperature of the receiving sensor and can be, for example, dynamically adapted to these conditions. This permits more accurate detection and measurement by the lidar device in changing ambient conditions.

In embodiments, the controller of the lidar device deliberately puts the receiving sensor into a state not ready to receive before the readiness time. This can take place, for example, by triggering the dead time before the readiness time or, for example, by deliberately influencing a bias voltage of the receiving sensor. If the receiving sensor comprises a field having multiple cells, for example, the average dead time across multiple cells or the maximum of the dead times in the field can be used. It is also possible that the top full width at tenth maximum of the dead times in the field is used, i.e. a value at which approximately 10% of the dead times in the field are above it and the others are below it.

In exemplary embodiments, the controller is configured to set the readiness time by actuating the receiving sensor, in particular by setting a light sensitivity of the receiving sensor. The readiness to receive depends here on the light sensitivity of the receiving sensor. Depending on the type of the receiving sensor, the readiness to receive can change gradually with the light sensitivity or the readiness to receive can be provided, for example, upon exceeding a certain threshold of the light sensitivity.

The setting of the light sensitivity can be influenced in particular by the setting of a bias voltage of the receiving sensor. It is possible to influence the sensitivity of receiving sensors, in particular of high-sensitivity light sensors such as APD, SPAD, SiPM by means of their bias voltage. In the present case, the bias voltage of the optical receiving sensors, for example the Geiger mode APD, can be controlled so that they are only activated after decay of internal reflections of the emitting light source of the lidar device.

In embodiments, the bias voltage of the receiving sensor can initially be set below the breakdown voltage in particular for avalanche photodiodes, so that they are initially not activated. The bias voltage is kept below the breakdown voltage and therefore in a deactivated state during the period during which internal reflections occur. Later-after decay of the internal reflections-the sensor is activated by increasing the bias voltage.

The readiness to receive of the receiving sensor is approximately switchable on or off by a so-called switchable bias voltage. The readiness to receive, for example, at the readiness time, can be switched on here, for example by setting to maximum light sensitivity. Before the readiness time, the readiness to receive of the receiving sensor remains switched off by a corresponding bias voltage. When the readiness to receive is switched off, internal reflections are thus not received. The readiness time is then selected so that the internal reflections have then decayed. As a result, even very close objects in front of the sensor are measurable in distance and position from the time of the readiness to receive.

In addition, the sensitivity of the light sensors can optionally be adapted to the signal level to be expected using the deliberate control of the bias voltage and thus, for example, the signal-to-noise ratio can be optimized. In addition to the dependence on temperature and ambient light, this can also relate to the expected intensity of the received reflections. For example, for objects in the close range of the lidar device, much greater reflected intensity, thus amount of light, is expected than from objects which are very far away.

The light sensitivity of the receiving sensor can be adapted by a corresponding setting of the bias voltage so that the light sensitivity increases in the course of a measuring cycle in order to be adapted to the lower intensity of the received reflections of objects which are farther away. A course of the bias voltage can be determined here with regard to the time sequence of the measuring cycle and a sensitivity characteristic of the receiving sensor.

The bias voltage can in particular be increased degressively, linearly, quadratically, and/or in steps in the course of a measuring cycle. A degressive increase means here that the increase of the light sensitivity decreases in the course of the measuring cycle, i.e. the slope of the light sensitivity curve becomes increasingly smaller. A step-by-step change of the bias voltage offers the advantage of a simpler system design and in particular circuit design.

The deliberate setting of the receiving sensor in a state not ready to receive before the readiness time can be carried out in particular by an optical prior triggering of the one or more light-sensitive elements of the receiving sensor. The dead time is started before the readiness time by the optical prior triggering so that the receiving sensor is deliberately ready to receive again at the readiness time.

The prior triggering by the deliberate triggering of the light sensor to put the receiving sensor in readiness to receive at the readiness time can be achieved, for example, by a trigger light source actuated offset in time and/or by, for example, a deliberate time curve of the actual light energy of emission light.

In one embodiment, the controller is configured to set the readiness time by the triggering of the trigger light source, the trigger light of which is incident on the receiving sensor so that it is ready to receive at the readiness time. In particular, the trigger time, at which the triggering of the trigger light source is provided, can be before the emission time. In particular, the trigger light of the trigger light source can be intended to trigger the dead time in the receiving sensor without readiness to receive so that the receiving sensor is then ready to receive at the readiness time.

The trigger light source is preferably designed in particular with respect to light propagation and power so that as much as possible all cells of the receiving sensor are reached and triggered. Distance between trigger time and emission time can advantageously be adapted during the operation of the lidar device, for example to compensate for temperature influences and/or changes of the intensity of the background light.

Alternatively or additionally, the controller can be configured so that it sets the readiness time by actuating the emission light so that the receiving sensor is ready to receive at the readiness time. This can in particular comprise a change of the intensity of the emission light. The intensity of the emission light can be increased in the course of the emission here. It is particularly advantageous here to emit emission light at lower intensity at the beginning of the emission. This emission light at lower intensity is then incident by internal reflections on the receiving sensor and puts it into a state not ready to receive during the dead time. The dead time without readiness to receive is triggered here so that the receiving sensor is then ready to receive at the readiness time. The maximum intensity of the emission light can then be reached, for example, at the emission time.

Preferably, the design here is in particular with respect to the emission power at the beginning for the purpose of triggering the cells so that as much as possible all cells of the light sensor are reached and triggered. The delay time of the start of the emission light at reduced intensity until reaching the maximum intensity can advantageously be adapted, for example to compensate for temperature influences and/or changes of the intensity of the background light.

### LIST OF FIGURES

Exemplary embodiments of this application are explained and described in more detail hereinafter on the basis of the figures. In the figures:

FIG. 1 schematically shows a lidar system having emitting and receiving unit,

FIG. 2 schematically shows the setting of the light sensitivity of the receiving sensor,

FIG. 3+4 show schematic illustrations of internal reflections,

FIG. 5+6 schematically show the light sensitivity of the receiving sensor with dead times, and

FIG. 7 shows a vehicle having a lidar system.

In the figures, identical reference signs are used for identical or similar elements. Illustrations in the figures may not be to scale.

### DESCRIPTION OF THE FIGURES

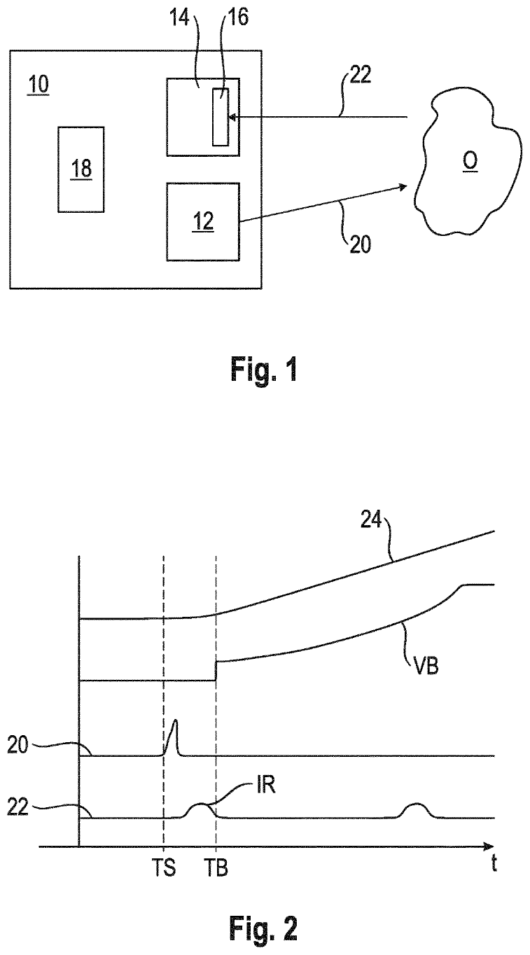

FIG. 1 schematically shows a lidar device 10. The lidar device 10 comprises an optical emitting unit 12 and an optical receiving unit 14 having a receiving sensor 16. An emission procedure of emission light 20 in the emitting unit 12 and a reception procedure of reception light 22 in the receiving unit 14 can be supervised and controlled by a controller 18. The controller 18 can be arranged, for example, on a computing unit having processor and memory of the lidar device 10 and can be implemented on such a computing unit, for example, as software.

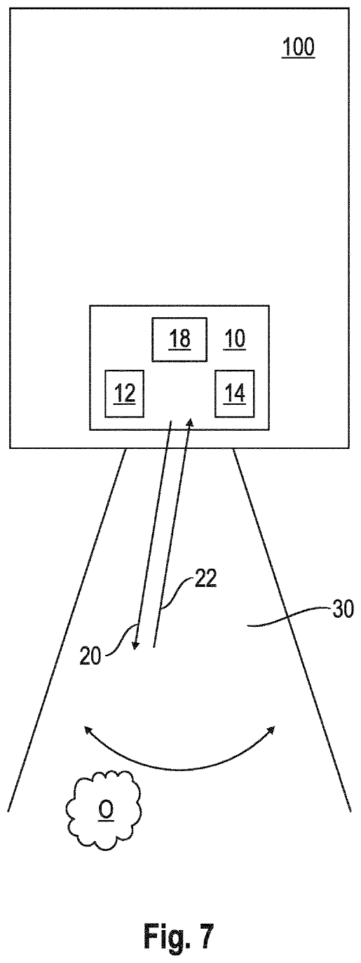

The lidar device 10 can be used to detect, thus sense, stationary or moving objects O, in particular vehicles, persons, animals, plants, obstacles, roadway irregularities, in particular potholes or rocks, roadway boundaries, traffic signs, free spaces, in particular parking spaces, precipitation, or the like in a detection area 30 (FIG. 7). The distance to the object O and/or the direction in which the object O is located can be determined, for example, by evaluation of the emission light 20 and the reception light 22 by the controller 18. Alternatively or additionally, a relative velocity in relation to the object O and/or properties of the object O can be determined. Information about properties of the object O can be obtained, for example, by evaluating intensities of the reception light 22.

The receiving sensor 16 comprises a light-sensitive element, but preferably multiple light-sensitive elements, which can convert received light into an electric current, which can be read out and evaluated by a downstream electrical circuit. The light-sensitive elements of the receiving sensor 16 can be designed, for example, as avalanche photodiodes (APD), as so-called single photon avalanche diodes (SPAD), or as a field of multiple interconnected APDs or SPADS, as a so-called silicon photomultiplier SiPM. Fields of photodiodes can receive reception light 22 from multiple directions at the same time. Single photodiodes of a SiPM are also referred to as cells. It can be provided that each cell of a SiPM receives reception light 22 from a different direction.

FIG. 2 shows, plotted over a time axis t, the light sensitivity 24 of a light-sensitive element, for example an avalanche photodiode. The light sensitivity 24 can be set via a bias voltage VB. In the example shown, the bias voltage VB is increased in steps at a readiness time TB. This results in the increase of the light sensitivity 24 of the light-sensitive element. In the example shown, the light sensitivity 24 of the light-sensitive element increases approximately linearly from the readiness time TB. The light-sensitive element is ready to receive from the readiness time TB. The relationship between bias voltage VB and light sensitivity 24 of the light-sensitive element depends on the type of the light-sensitive element.

The bias voltage VB is thus controlled over time so that it is reduced during the internal reflection phase below the breakdown voltage of the light-sensitive elements, so that the receiving sensor 16 is initially not activated. The bias voltage VB is then increased above the breakdown voltage of the light-sensitive elements, so that the receiving sensor 16 can be activated for the object measurement. This means that the bias voltage VB is changed over time to regulate the light sensitivity of the light-sensitive elements. This means that the receiving sensor 16 is initially deactivated for the phase of the occurrence of the internal reflections IR and is then activated by controlling the bias voltage VB. The bias voltage VB can be changed continuously over time in order to regulate the sensitivity of the light sensor. Furthermore, a step-by-step change of the bias voltage VB can be carried out. For example, the bias voltage VB can be designed as switchable. The readiness to receive of the receiving sensor 16 is switched on or off by the so-called switchable bias voltage VB. Alternatively, the bias voltage VB can be implemented, for example, by charging a capacitor.

The light sensitivity of the light-sensitive element, in particular an avalanche diode, depends on the bias voltage VB, which can be applied as an overvoltage above the breakdown voltage of the diode. To reduce the light sensitivity of the light-sensitive element, the bias voltage can be reduced and in particular can be reduced below the breakdown voltage to deactivate the receiving sensor 16. The bias voltage VB is preferably not reduced far below the breakdown voltage of the light-sensitive element, in order to enable a rapid increase of the sensitivity at the readiness time TB.

Emission light 20 is emitted at an emission time TS. This is represented in FIG. 2 by an increase of the intensity of the emission light 20. At the time TS, an emission light pulse is thus emitted. Due to internal reflections IR of the lidar device 10, a first back reflection of the reception light 22 which originates from internal reflections IR initially reaches the receiving sensor 16. A detection of these internal reflections IR is undesired. The readiness time TB was therefore selected so that when the first internal reflections IR are incident on the receiving sensor 16, it is not yet ready to receive. The incidence of the first back reflections, originating from the internal reflections IR, of the reception light 22 is before the readiness time TB. The bias voltage VB is increased at the readiness time TB, so that after the readiness time TB, the light-sensitive element or the light-sensitive elements of the receiving sensor 16 is or are ready to receive. The following reflection of emission light 20 is incident as reception light 22 on the receiving sensor 16 later, after the readiness time TB. This reflection can be detected as intended by the lidar device 10 having receiving sensor 16 ready to receive.

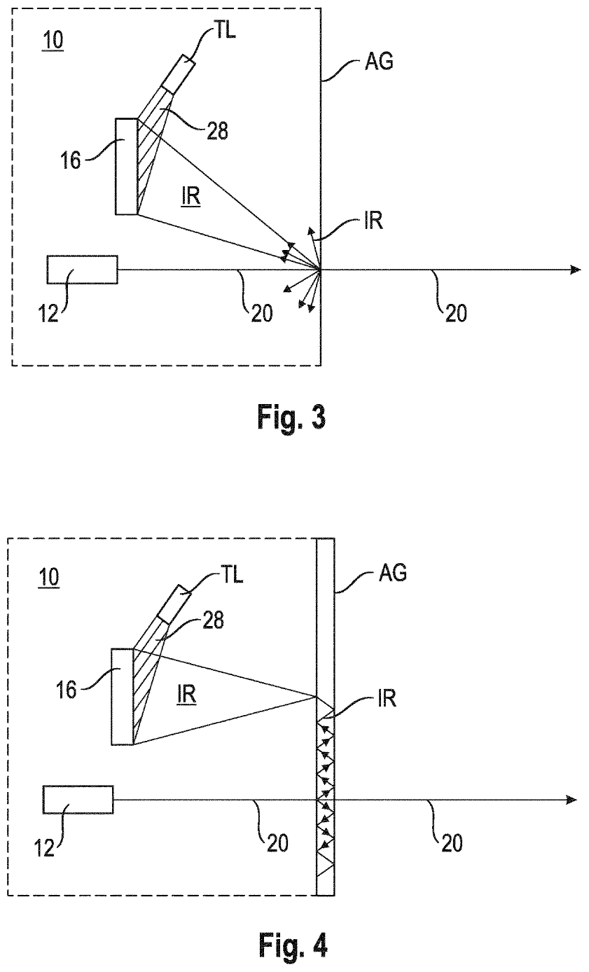

FIG. 3 schematically shows a lidar device 10. The optical emitting unit 12 emits emission light 20. The occurrence of internal reflections IR is shown by way of example in FIG. 3. A part of the emission light 20 is reflected on the cover glass AG of the housing of the lidar device 10. A part of these internal reflections IR is incident on the receiving sensor 16. These internal reflections IR are undesired. If the receiving sensor 16 receives them, its light-sensitive elements are put into a state after the reception during a dead time TZ, in which the light-sensitive elements are not ready to receive.

Reflections of the emission light 20 on objects O outside the lidar device 10 would not be able to be received by the receiving sensor 16 during this dead time TZ. Therefore, in the exemplary embodiment of FIG. 3 and FIG. 4, a trigger light source TL is provided. The trigger light source TL can emit trigger light 28 onto the receiving sensor 16. Due to the trigger light 28, the light-sensitive elements of the receiving sensor 16 are initially put into a state in which they are not ready to receive during the dead time TZ upon reception of the trigger light 28. This dead time TZ is selected so that it coincides with the incidence of the internal reflections IR on the receiving sensor 16. After decay of the internal reflections IR and after the end of the dead time TZ, the receiving sensor 16 is therefore ready to receive at a readiness time TB. The trigger time TT, at which the trigger light source TL is triggered, is therefore preferably selected so that the dead time TZ of the light-sensitive elements of the receiving sensor 16 triggered by the trigger light 28 is ended and the receiving sensor 16 is ready to receive at the readiness time TB.

FIG. 4 shows the lidar device 10 having trigger light source TL on the basis of the exemplary embodiment of FIG. 3. Internal reflections IR, which can arise within the cover glass AG on the two surfaces of the cover glass AG, are illustrated in FIG. 4. The optical emitting unit 12 emits emission light 20. Parts of the emission light 20 are reflected as internal reflections IR within the cover glass AG of the lidar device 10 and are incident as internal reflections IR on the receiving sensor 16. The incidence of these internal reflections IR on the receiving sensor 16 is also undesired, since, as described with reference to FIG. 3, it can trigger dead times TZ of the light-sensitive elements of the receiving sensor 16. Therefore, the trigger light source TL is provided, which emits the trigger light 28 onto the receiving sensor at the trigger time TT so that as much as possible all cells are struck by the trigger light 28.

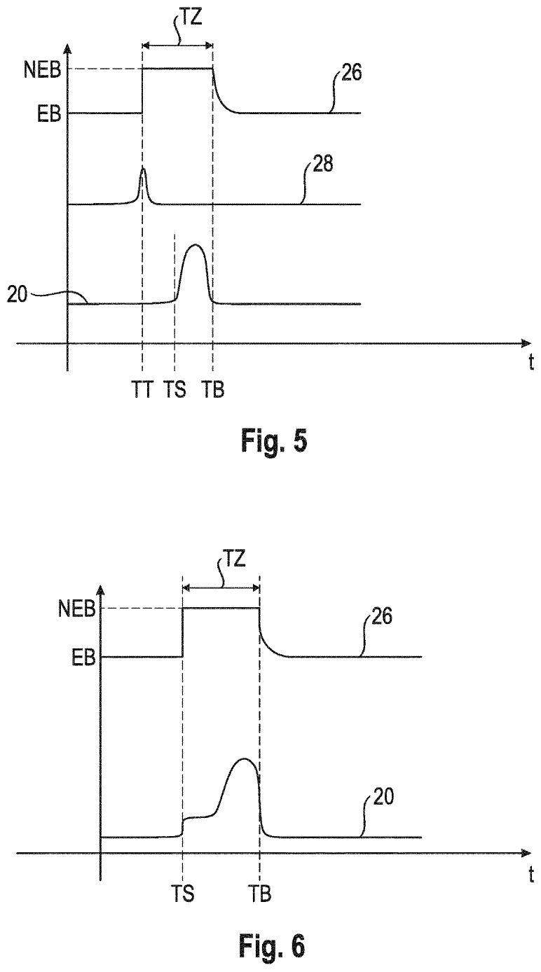

The functionality of the exemplary embodiment of FIGS. 3 and 4 is shown by way of example in FIG. 5. The light sensitivity 26 of the optical elements of the receiving sensor 16 is shown by way of example. In the example shown, the state EB of the light sensitivity 26 refers to a readiness to receive of the light-sensitive element and the state NEB refers to a non-readiness to receive of the light-sensitive element. In the illustrated example, a dead time TZ of the light-sensitive element is triggered at the trigger time TT by the trigger light 28. During the dead time TZ, the light-sensitive element is in a not-ready-to-receive state NEB. At an emission time TS, which is after the trigger time TT, the intensity of the emission light 20 is increased so that a measuring cycle is started. The readiness to receive at the readiness time TB is reached shortly after the end of the emission light pulse of the emission light 20. The readiness time TB coincides with the end of the dead time TZ in the example shown. The readiness time TB is selected here so that it occurs after the decay of internal reflections IR. After the readiness time TB, the light-sensitive element of the receiving sensor 16 is ready to receive reflections on objects O and to detect these objects O.

FIG. 6 schematically shows the mode of operation of a further embodiment of the application. In the example shown, the intensity of the emission light 20 is increased at an emission time TS. This increase initially takes place to a minor extent and so that internal reflections occur in the lidar device due to this emission light 20 having lower intensity and are incident on the receiving sensor 16. This triggers a dead time TZ in the light-sensitive elements of the receiving sensor 16 and puts them into a not-ready-to-receive state NEB. At the readiness time TB, the light sensitivity 26 of the light-sensitive elements returns back to the ready-to-receive state EB.

The invention of the emission light 20 with more and in particular full intensity now takes place with a delay. It takes place so that the full intensity of the emission light 20 is first reached after the emission time TS but before reaching the readiness to receive EB at the readiness time TB of the light-sensitive elements of the receiving sensor 16.

Internal reflections IR are thus incident on the receiving sensor 16 while it is in the not-ready-to-receive state NEB during its dead time TZ. The readiness time TB only occurs thereafter and the receiving sensor 16 is in the ready-to-receive state EB to receive reflections on objects O in the detection area 30 of the lidar device 10.

FIG. 7 schematically shows a vehicle 100, for example a passenger vehicle. The lidar device 10 is arranged in a front area of the vehicle 100. The emission light 20 and the reception light 22 can be evaluated by the controller 18 for the detection, distance determination, and/or velocity determination for the object O located in the detection area 30.

The detection area 30 is located in front of the front area of the vehicle 100. An area in front of the vehicle 100 in the direction of travel can thus be monitored in the example shown. It is also possible to arrange the lidar device 10 in other areas of the vehicle 100, for example in the rear area and/or in lateral areas. It is also possible to arrange multiple lidar devices 10 on the vehicle 100, in particular also in corner areas of the vehicle 100.

With a scanning lidar device 10, the detection area is successively scanned by the emission light 20. This is represented by the arrow in FIG. 7. With a flash lidar, the detection area can be illuminated simultaneously as a whole or in parts.

1. A lidar device for a vehicle, comprising:
an optical emitting unit having an emission light source for emitting emission light;
an optical receiving unit having an optical receiving sensor; and
a controller, which is configured to actuate the lidar device so that the receiving sensor (16) is ready to receive at a readiness time dependent on internal reflections, wherein the internal reflections relate to reflections of the emission light within the lidar device.

2. The lidar device as claimed in claim 1, wherein the internal reflections relate to reflections of the emission light on at least one optical element of the emitting unit, the receiving unit, and/or the housing.

3. The lidar device as claimed in claim 1, wherein the lidar device is configured to begin the emission of the emission light at an emission time, wherein the readiness time depends on the emission time of the emission light.

4. The lidar device as claimed in claim 1, wherein the readiness time depends on an ambient light power and/or a temperature of the receiving sensor.

5. The lidar device as claimed in claim 1, wherein the actuation of the lidar device by the controller comprises putting the receiving sensor in a not-ready-to-receive state before the readiness time.

6. The lidar device as claimed in claim 1, wherein the controller is configured to set the readiness time by actuating the receiving sensor by setting a light sensitivity of the receiving sensor.

7. The lidar device as claimed in claim 6, wherein the controller is configured to set the light sensitivity by setting a bias voltage of the receiving sensor.

8. The lidar device as claimed in claim 7, wherein the bias voltage is increased in a course of a measuring cycle, wherein the increase takes place degressively, linearly, quadratically, and/or in steps.

9. The lidar device as claimed in claim 7, wherein the bias voltage is implemented by charging a capacitor.

10. The lidar device as claimed in claim 3, wherein the controller is configured to set the readiness time by triggering a trigger light source, a trigger light of which is incident on the receiving sensor so that it is ready to receive at the readiness time.

11. The lidar device as claimed in claim 10, wherein a trigger time, at which the triggering of the trigger light source is provided, is before the emission time.

12. The lidar device as claimed in claim 1, wherein the controller is configured to set the readiness time by actuating the emission light so that the receiving sensor is ready to receive at the readiness time.

13. The lidar device as claimed in claim 12, wherein the actuation of the emission light comprises comprises an increase of an intensity of the emission light in a course of the emission.

14. A motor vehicle having a lidar device as claimed in claim 1.

15. A method for operating a lidar device having an optical emitting unit having an emission light source for emitting emission light and an optical receiving unit having an optical receiving sensor, the method comprising:
actuating the lidar device so that the receiving sensor is ready to receive at a readiness time dependent on internal reflections, wherein the internal reflections relate to reflections of the emission light within the lidar device.
